(19) United States
(12) Patent Application Publication
(10) Pub. No.: US 2026/0215631 A1
(43) Pub. Date: Jul. 30, 2026

(54) Waterless Outdoor Mobile Toilet with Automated Waste Treatment System

(71) Applicant: Victor Yadgar, Givat Koach (IL)

(72) Inventor: Victor Yadgar, Givat Koach (IL)

(21) Appl. No.: 19/356,080

(22) Filed: Oct. 11, 2025

Related U.S. Application Data
(60) Provisional application No. 63/750,278, filed on Jan. 27, 2025.

(51) Int. Cl. A47K 11/02; C02F 11/121; C02F 103/00

(52) U.S. Cl. CPC A47K 11/02; C02F 11/121; C02F 2103/005; C02F 2201/008

(57) ABSTRACT

The present invention comprises a waterless outdoor mobile toilet that includes a cabin having a first side wall, a second side wall, a rear wall, a top wall, a base wall, and a door pivotally connected to the first side wall or the second side wall via a hinge. The toilet further includes a toilet bowl with a toilet hole, a waste tank, and an automated waste treatment system. The automated waste treatment system includes a receiving plate disposed beneath the toilet hole, a separating net disposed beneath the receiving plate, a removal rod configured to traverse the receiving plate and to displace human waste from the receiving plate onto the separating net, and one or more separating rods configured to traverse the separating net and distribute the human waste across the separating net. The removal rod and the one or more separating rods are powered by a drive mechanism.

### CROSS-REFERENCE TO RELATED APPLICATIONS

This application claims priority from United States provisional patent application number 63/750,278, filed on January 27, 2025, which is hereby incorporated by reference.

### BACKGROUND OF THE INVENTION

Mobile toilets in use today use chemical substances or sawdust to cover human waste (feces and urine) of users of the mobile toilets. Use of these toilets causes harmful and unpleasant smells and signs of urine and feces, and often requires the removal of the human waste and chemical substances, often on a daily basis. Human waste disposal requires extensive resources, such as time, money, and equipment. Human waste disposal also exposes the personnel involved in the process to various kinds of sanitary hazards and bacteria.

Also, in the case of permanent toilets being offered as ecological solutions in locations without water, sewage, and electricity infrastructures, there is no separation of waste in the form of urine and feces. The toilet may sometimes be used without side effects of smell, but the unpleasant sight of human waste is still not prevented in these scenarios. Another drawback of permanent toilets is that they cannot be moved from place to place. In addition, it is required to clear the accumulated waste every so often.

The solutions that exist today for services without water, sewage, and electricity infrastructures are either mobile services that are provided at construction sites, festivals, etc., as chemical services and composting services based on adding chemicals, sawdust, or dispersing other materials in order to contradict the smell and visibility of waste, or permanent ecological services that can be seen in different public facilities and authorities, but cannot be moved from place to place.

There are other solutions based on systems of cleaning urine and feces by pools of water with plants that break down the human waste, but these systems require time and large areas to clean the water and are not feasible for local uses.

Therefore, in view of the foregoing, there exists a need in the art to overcome the aforementioned drawbacks associated with the existing types and therefore, the present invention aims to solve important hygiene, accessibility, and convenience problems related to the use of toilets, such as bad odor and sight. Accordingly, the solution offered aims to get rid of the unpleasantness of human waste, reduces the volume of waste and thus also reduces the need for waste removal, and allows the user of a significantly smaller collection container, thus turning green ecological toilets into mobile toilets, along with other significant advantages, forming a part of the present invention, and described hereinbelow.

### SUMMARY OF THE INVENTION

This summary is provided to introduce a selection of concepts in a simplified form to be further described below in the Detailed Description. This summary is not intended to be used to limit the scope of the claimed subject matter.

Embodiments of the present invention comprise a toilet. The toilet may be a mobile toilet that is placed on the ground in a first location and is not secured to the ground by any sort of fastener. The mobile toilet may be moved from the first location without damaging the toilet. Depending on the size of the toilet, the mobile toilet may be moved by human force or by a moving mechanism such as but not limited to a winch, rollers, forklift, etc.

The toilet may comprise a cabin with a first side wall, a second side wall, a rear wall, a top wall, a base wall, and a door. The door may be pivotally connected to the first side wall or to the second side wall via a hinge. In some embodiments, the door may be pivotally connected to the first side wall or to the second side wall via multiple hinges. The door may swing about the hinge/hinges relative to the first side wall and second side wall so that a user may entire the cabin to use the toilet.

A toilet bowl of the toilet may comprise a toilet hole through which a user may deposit human waste such as feces and urine. A waste tank may be disposed below the toilet hole such that human waste deposited through the toilet hole may fall into the waste tank by the force of gravity.

An automated waste treatment system of the toilet may comprise a drive mechanism. The drive mechanism may be powered by an electric motor. The electric motor may be operated by a micro switch, which is a small, fast-operating, snap-action switch that uses a spring-loaded lever to quickly make or break an electrical circuit with minimal force. The micro switch may be configured on the door and may be activated upon opening or closing the door relative to the first side wall or the second side wall. The micro switch may alternatively be configured on the first side wall or the second side wall and may be activated upon opening or closing the door relative to the first side wall or the second side wall.

In some embodiments, the electric motor may be activated by a separation magnet that uses positioning of two magnets relative to one another to manipulate a magnetic field to make or break an electrical circuit. Portions of the separation magnet may be configured on the door and on either the first side wall or the second side wall. The separation magnet may be activated upon opening or closing the door relative to the first side wall or the second side wall.

In some embodiments, the drive mechanism may not be powered by an electric motor, and may alternatively be powered mechanically by a transmission. The transmission may be operatively coupled to the hinge of the toilet and may be configured to utilize rotational movement of the door about the hinge to actuate the drive mechanism. The transmission may accomplish this by means of mechanical components such as but not limited to gears and/or linkages.

The automated waste treatment system may also comprise a receiving plate disposed beneath the toilet hole and configured to receive human waste thereupon. A removal rod may be operatively coupled to the drive mechanism and may be positioned horizontally above the receiving plate. Actuation of the drive mechanism may cause the removal rod to traverse the receiving plate and displace the human waste from the receiving plate. The removal rod may be one or more removal rods. The removal rod may traverse the receiving plate at a distance of 5mm or less from a top surface of the receiving plate that faces the toilet hole. Further, the removal rod may traverse the receiving plate at a distance of 2mm or less from the top surface of the receiving plate. The removal rod may traverse the receiving plate along a circular path with one or more radii of curvature. Alternatively, the removal rod may traverse the receiving plate along one or more linear paths, each having no radius of curvature.

A separating net may be disposed below the receiving plate. When human waste is displaced from the receiving plate by the removal rod, the human waste may be received by the separating net. The separating net may have a separating net upper surface upon which feces of the human waste are retained. The separating net may further have a plurality of separating holes through which urine of the human waste passes into the waste tank. The separating holes may each have a separating hole width of 10mm or less, 5mm or less, 2mm or less, or any width between or including the values provided. The separating net may be made of any material such as but not limited to metal, rigid plastic, or a flexible material commonly used in nets such as but not limited to nylon or hemp. In embodiments wherein the separating net is made of a flexible material such as nylon or hemp, the separating net may be stretched across the waste tank with adequate tension such that the separating net is configured across a single horizontal plane.

One or more spreading rods may be operatively coupled to the drive mechanism. The one or more spreading rods may be positioned horizontally above the separating net. Actuation of the drive mechanism may cause the one or more spreading rods to traverse the separating net and distribute the feces across the separating net. This prevents a pile of feces from accumulating on the separating net and causing unpleasant smells and/or sights. The one or more spreading rods may traverse the separating net at a distance of 5mm or less from the separating net upper surface. Further, the one or more spreading rods may traverse the separating net at a distance of 2mm or less from the separating net upper surface. In some embodiments, multiple spreading rods may be provided, and each may be configured at a different height above the separating net upper surface. Each of the one or more spreading rods may traverse the separating net along a circular path with one or more radii of curvature. Alternatively, the one or more spreading rods may each traverse the separating net along one or more linear paths, each having no radius of curvature.

In some embodiments, the feces of the human waste is moved underneath the receiving plate by the one or more spreading rods to conceal the human waste from view. In some embodiments, the one or more spreading rods are replaced by one or more spreading fans, each with one or more blades that rotate about a central axis. The one or more blades may contact the feces to spread the feces about the separating net. The one or more spreading fans may operate at 5mm above the separating net upper surface, 2mm above the separating net upper surface, or at various heights above the separating net upper surface in embodiments with multiple separating fans.

Additional aspects, advantages, features, and objects of the present disclosure would be made apparent from the drawings and the detailed description of the illustrative embodiments construed in conjunction with the appended claims that follow. It will be appreciated that features of the present disclosure are susceptible to being combined in various combinations without departing from the scope of the present disclosure as defined by the appended claims.

### BRIEF DESCRIPTION OF DRAWINGS

FIG. 1 shows a perspective view of a fecal dispersion mechanism based on a centrifuge and wipers, in accordance with an embodiment of the present invention.

FIG. 2 shows a perspective view of a fecal dispersion mechanism based on a conveyor belt with wipers, in accordance with embodiments of the present invention.

FIG. 3 shows a perspective view of a fan-based fecal dispersal mechanism, in accordance with embodiments of the present invention.

FIG. 4 shows a front view of a mobile toilet, in accordance with embodiments of the present invention.

FIG. 5 shows a side view of a mobile toilet, in accordance with embodiments of the present invention.

FIG. 6 shows a perspective of view of portions of a toilet and a receiving plate, in accordance with embodiments of the present invention.

FIG. 7 shows a perspective view of an automated waste treatment system, in accordance with embodiments of the present invention.

FIG. 8 shows a perspective view of an automated waste treatment system, in accordance with embodiments of the present invention.

### DETAILED DESCRIPTION OF THE INVENTION

The accompanying drawings are included to provide further understanding of the present disclosure, and are incorporated in and constitute a part of this specification. The drawings illustrate example embodiments of the present invention and, together with the description, serve to explain the principles of the present disclosure.

In the figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

Example embodiments will now be described more fully hereinafter with reference to the accompanying drawings, win which example embodiments are shown. These example embodiments are provided for illustrative purposes so that this disclosure will be thorough and complete and will fully convey the scope of the present invention to those of ordinary skill in the art. The invention disclosed may, however, be embodied in many different forms and should not be construed as limited to the embodiments set forth herein. Various modifications will be readily apparent to persons skilled in the art.

The general principles defined herein may be applied to other embodiments and applications without departing from the spirit and scope of the invention. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure). Also, the terminology and phraseology used is for the purpose of describing example embodiments and should not be considered limiting. Thus, the present invention is to be accorded the widest scope encompassing numerous alternatives, modifications and equivalents consistent with the principles and features disclosed. For the purposes of clarity, details relating to technical material that is known in the technical fields related to the invention have not been described in detail so as not to unnecessarily obscure the present invention.

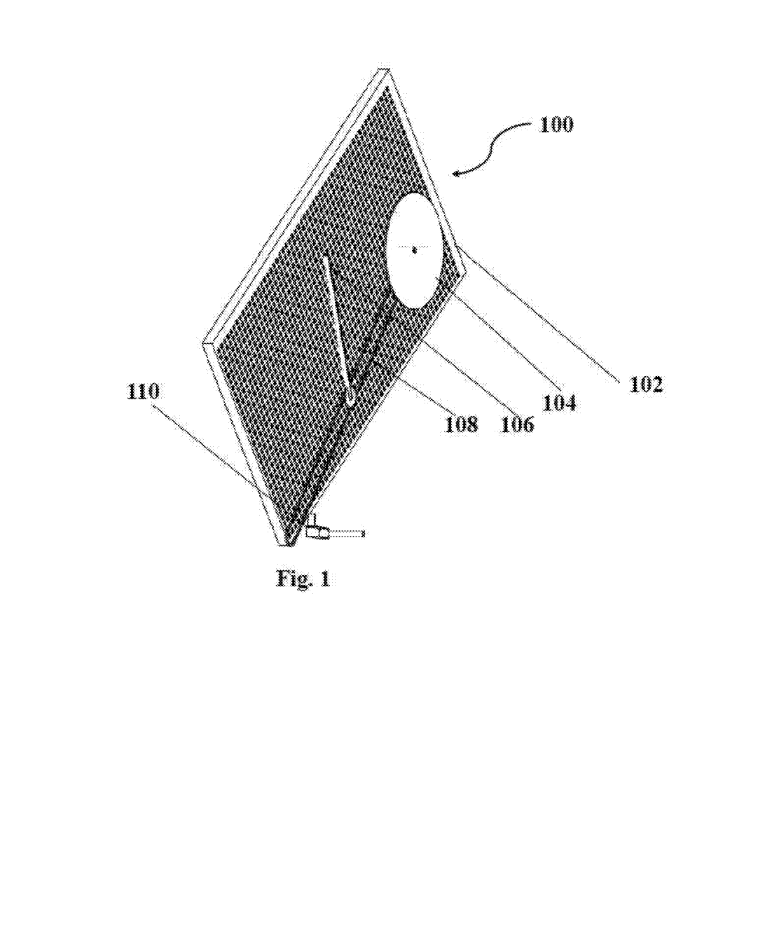

As shown in FIG. 1, a mobile toilet includes a fecal dispersion mechanism 100 based on a centrifuge and wiper. The mobile toilet may comprise a collection container for receiving human waste. There is an operating mechanism 110 of the fecal dispersion mechanism 100 that is either mechanically or electrically operated, and is connected to a door of the mobile toilet or to an associated hinge, such that the operating mechanism 110 is activated when the door is opened and closed. The operating mechanism 110 can be activated by a micro switch or a separation magnet or any other electrical command that activates an electric drive system or any other suitable means, as can be conceived by a person skilled in the art. The operating mechanism 110 is installed inside the collection container and is made of any liquid impermeable materials such as metal, plastic, etc. The operating mechanism 110 may be connected to the door or hinge directly in connection with a vertical or angular gear, which may mate with other gears or to a chain, band, etc.

A concealing plate 104 can be cleared of human waste by a centrifugal system that rotates the concealing plate 104. The centrifugal system may be either directly or indirectly connected to the door or an associated hinge. The centrifugal system may be connected to a drive mechanism 108, which may be connected to the operating mechanism 110, which when activated, causes the concealing plate 104 to rotate to disperse human waste configured on the concealing plate 104.

The operating mechanism 110 may activate the drive mechanism 108 which may activate a system of wiper blades 106. Movement of the wiper blades 196 may cause evacuation of the surface 102 on which human waste falls when being removed from the concealing plate 104. The wiper blades 106 may alternatively spread the human waste across the surface 102 onto which the human waste falls when being removed from the concealing plate 104.

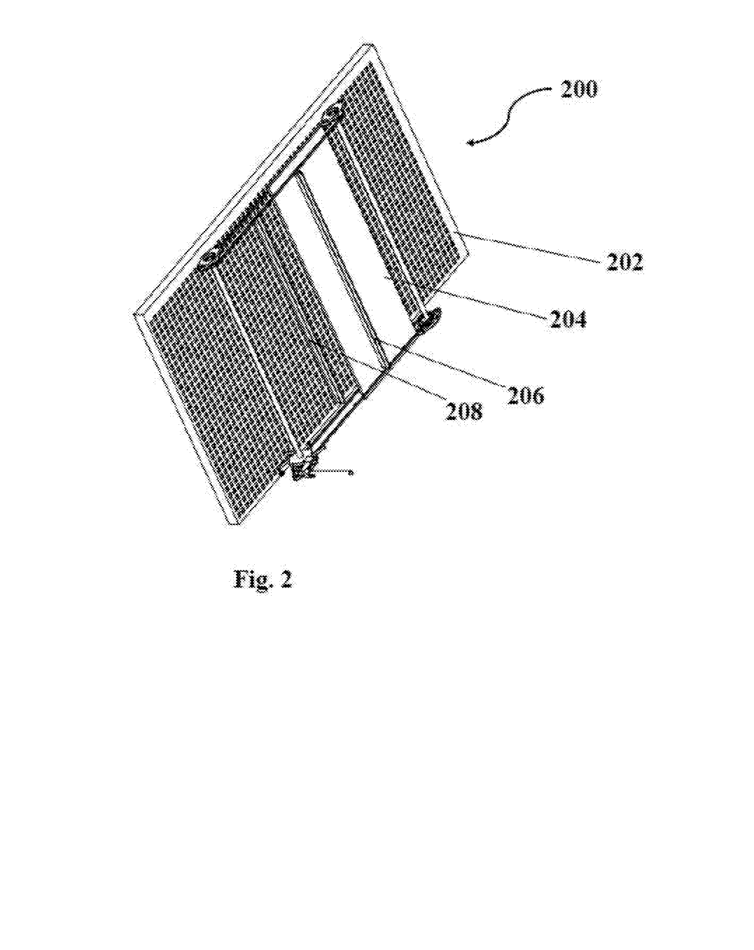

As shown in FIG. 2, a mobile toilet includes a fecal dispersion mechanism 200 based on a conveyor belt with wipers 206 and mops 208. Human waste falls onto a concealing plate 204 and is evacuated from the concealing plate 204 by movement of the wipers 206. The human waste then falls to a separation net 202 through which urine of the human waste may fall and across which feces of the human waste may be dispersed by the wipers 206 and the mops 208. The wipers 206 and mops 208 may be configured at different heights above the separation net 202 and/or concealing plate.

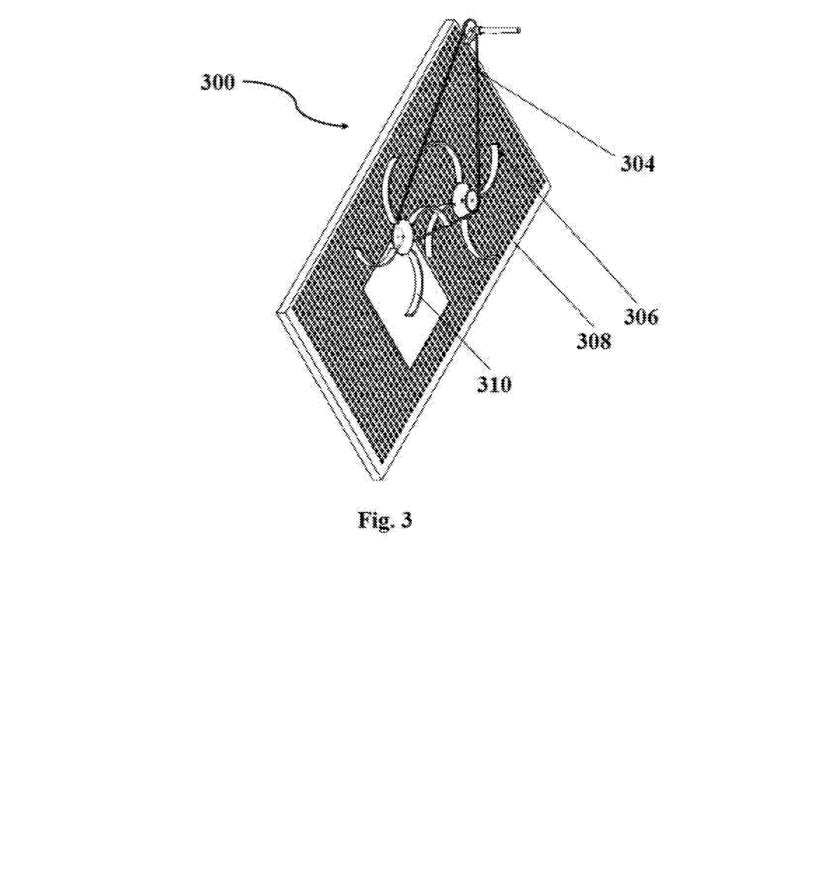

As shown in FIG. 3, a mobile toilet includes a fecal dispersion mechanism 300 based a series of fans. A first fan 306 and a second fan 310 may both be connected to a drive mechanism 304, which may be a chain or driveshaft. This does not limit these embodiments of the present invention to comprise only two fans. Various embodiments may comprise any number of fans. The first fan 306 and second fan 310 may be configured at various heights relative to a concealing plate and a separation net 308 to evacuate human waste from the concealing plate and to disperse the human waste across the separation net 308. When the human waste is dispersed across the separation net 308, urine of the human waste may fall through the separation net 308 and feces from the human waste may be retained on the separation net 308.

In additional embodiments, the mobile toilet may include a ventilation system comprising passive vents that may be operated by wind. The vents may alternatively be active electric vents which may be powered by solar electricity or other sources of electricity. The ventilation system may cause faster drying of the human waste and may oxidize the human waste, thereby removing foul odors from the waste tank. Drying of the human waste may also be accomplished by a heating element powered by electricity. Drying of the human waste reduces the volume of human waste since water is evaporated from the human waste. This allows the waste tank to be a smaller size and allows the mobile toilet to be emptied less frequently. It also reduces unpleasant sights of human waste in the toilet.

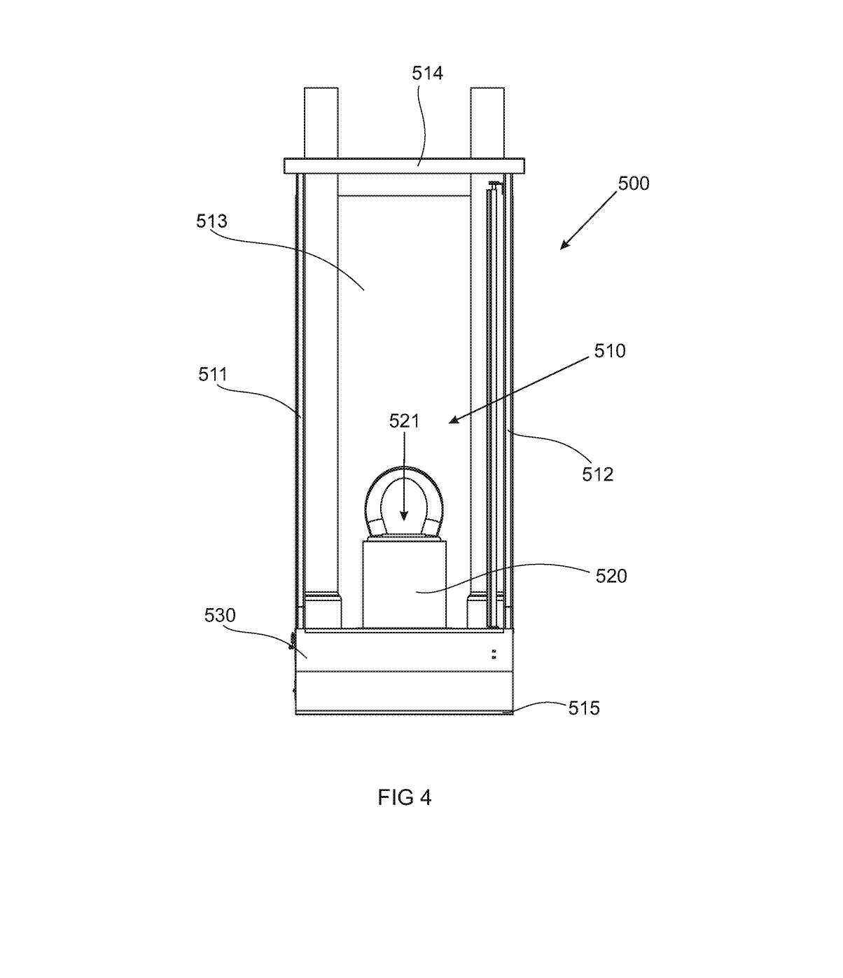

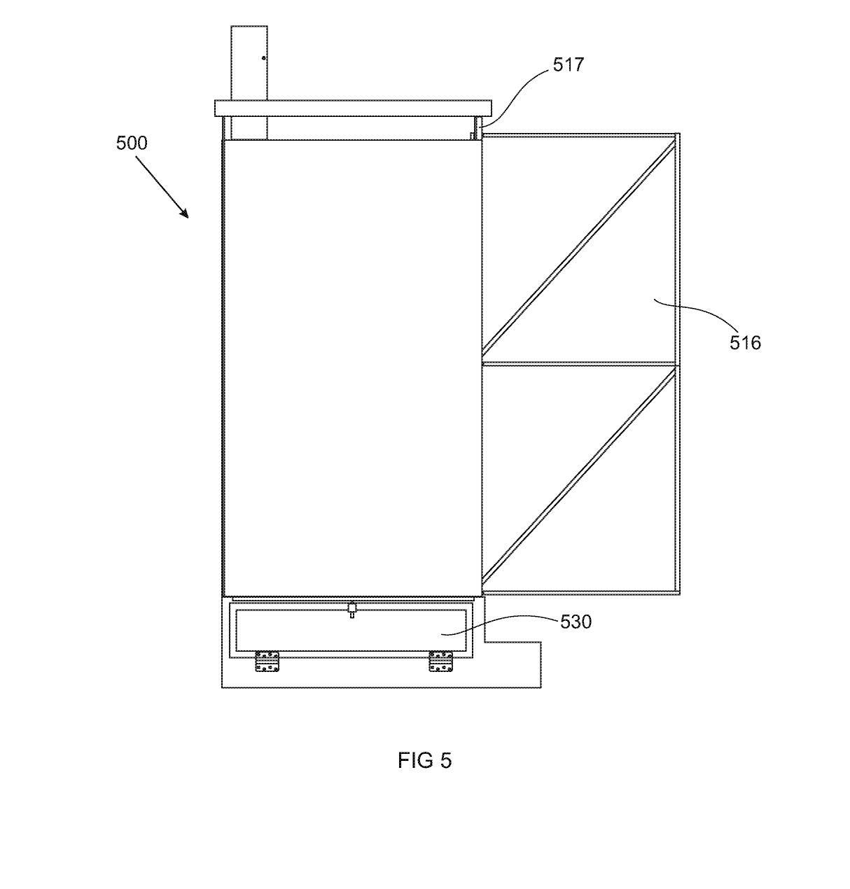

As shown in FIG. 4-5, a mobile toilet 500 has a generally box-shaped cabin 510 comprising a first side wall 511, a second side wall 512, a rear wall 513, a top wall 514, a base wall 515, and door 516. The door is pivotally connected to either the first side wall 511 or the second side wall 512 by a hinge 517, allowing access to the interior of the cabin 510. Positioned within the cabin 510 is a toilet bowl 520 including a toilet hole 521 through which human waste may be deposited during use. Below the toilet hole 521 is a waste tank 530 which serves as a collection container for the human waste.

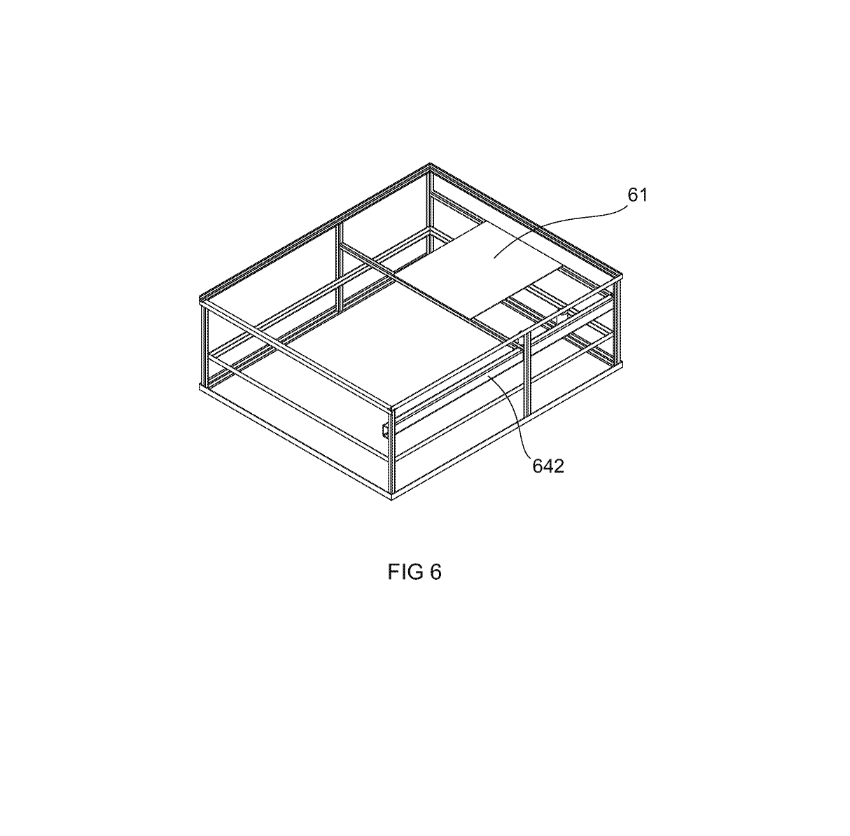

As shown in FIGS. 6-8, An automated waste treatment system 60 is provided within the cabin 510 of the mobile toilet 500, and may be positioned beneath the toilet hole 521. The automated waste treatment system 60 is configured to separate and manage fecal and liquid waste efficiently without water. The automated waste treatment system 60 includes a receiving plate 61 disposed directly below the toilet hole 521. The receiving plate 61 is configured to catch feces as they fall from the toilet bowl 520 and to hide feces accumulated underneath. In this manner, the receiving plate 61 functions similarly to the concealing plate described in previous embodiments of the present invention herein.

Positioned below the receiving plate 61 is a separating net 62. The separating net 62 comprises a plurality of separating net holes 621 sized to allow urine and other liquid waste to pass through into the waste tank 530 while simultaneously retaining feces on a separating net upper surface 622 for further processing. To facilitate the movement of waste from the receiving plate 61 to the separating net 62, a removal rod 63 is provided. The removal rod 63 is arranged horizontally above the receiving plate 61 and is operatively connected to a drive mechanism 64. Upon actuation, the drive mechanism 64 causes the removal rod 63 to traverse the receiving plate 61, thereby pushing the waste off the receiving plates 61 and allowing it to fall onto the separating net 62. Once the waste falls onto the separating net 62, urine may fall through the separating net holes 621. One or more spreading rods 65 are employed to evenly distribute feces across the separating net 62. The one or more spreading rods 65 are operatively coupled to the drive mechanism 64. When operated, the drive mechanism 64 moves the spreading rods 65 horizontally across the receiving net 62 to ensure an even spread of feces, which aids in ventilation, drying, and subsequent handling of the feces.

In some embodiments, the drive mechanism 64 may be an electric drive mechanism powered by an electric motor. In other embodiments, the drive mechanism 64 may be a mechanical drive mechanism powered by a transmission 642. The transmission 642 is operatively coupled to the hinge 517 of the mobile toilet such that when the door 516 is opened or closed, the rotational movement of the hinge 517 is harnessed to actuate the drive mechanism 64. This configuration provides a waterless, electrically independent option for waste treatment in remote or off-grid locations. When the user of the mobile toilet opens the door 516 to leave the cabin 510, the drive mechanism 64 will cause the removal rod 63 to push human waste off the receiving plate 61 and the one or more spreading rods 65 to spread feces of the human waste that are already on the separation net 62 from the previous use of the toilet. When the user closes the door 516, the drive mechanism 64 will cause the one or more spreading rods 65 to spread that user’s feces across the separation net 62.

The operation of the automated waste treatment system utilizing the drive mechanism allows waste to be disposed of without any extra action being performed by the user, such as activating a flushing lever. The human waste is disposed of by the user simply opening and closing the door to the toilet. This provides a more convenient and sanitary waste disposal solution.

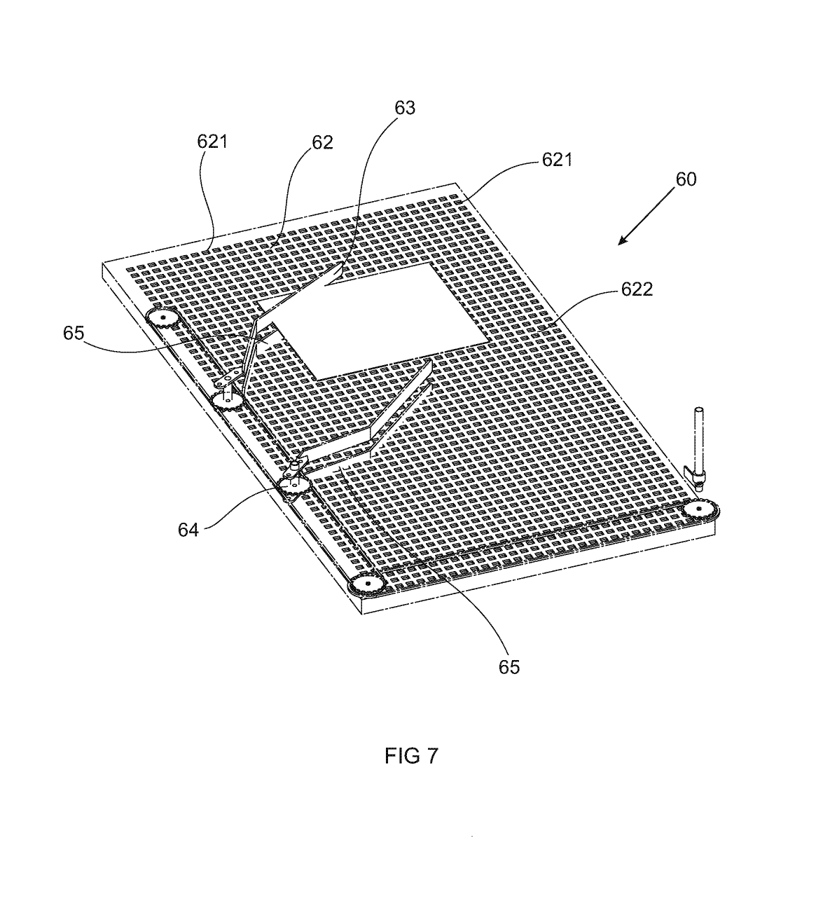

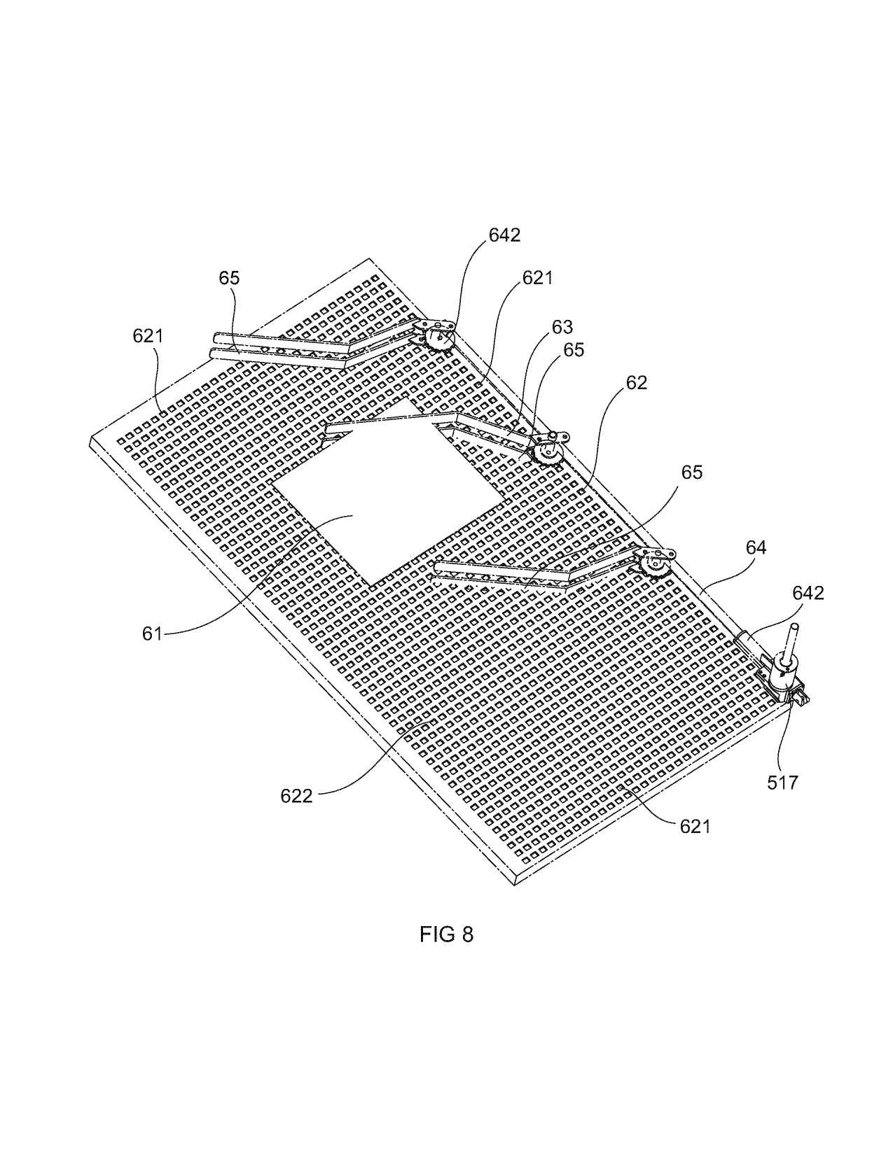

It should be noted that in FIGS. 7-8, the removal rod 63 may be shown as one or more removal rods.

1. A toilet comprising:
a cabin comprising:
first side wall;
a second side wall;
a rear wall;
a top wall;
a base wall;
a door pivotally connected to the first side wall or the second side wall via a hinge;
a toilet bowl comprising a toilet hole;
a waste tank;
an automated waste treatment system comprising:
a drive mechanism;
a receiving plate disposed beneath the toilet hole and configured to receive human waste thereupon;
a removal rod operatively coupled to the drive mechanism and positioned horizontally above the receiving plate, wherein actuation of the drive mechanism causes the removal rod to traverse the receiving plate and displace the human waste from the receiving plate;
a separating net disposed below the receiving plate and configured to receive the human waste displaced from the receiving plate, the separating net comprising:
a separating net upper surface upon which feces of the human waste are retained;
a plurality of separating net holes through which urine of the human waste passes into the waste tank; and
one or more spreading rods operatively coupled to the drive mechanism and positioned horizontally above the separating net, wherein actuation of the drive mechanism causes the one or more spreading rods to traverse the separating net and distribute the feces across the separating net.

2. The toilet of claim 1, wherein the toilet is mobile,
whereby the toilet is placed on the ground in a first location and is not secured to the ground by any sort of fastener;
and whereby the toilet is moved from the first location without damaging the toilet.

3. The toilet of claim 1, wherein the drive mechanism is powered by an electric motor.

4. The toilet of claim 3, wherein the electric motor is activated by a micro switch.

5. The toilet of claim 3, wherein the electric motor is activated by a separation magnet.

6. The toilet of claim 1, further comprising a transmission operatively coupled to the hinge and configured to utilize rotational movement of the door about the hinge to actuate the drive mechanism.

7. The toilet of claim 1, wherein the removal rod traverses the receiving plate along a linear path.

8. The toilet of claim 1, wherein the removal rod traverses the receiving plate along a circular path.

9. The toilet of claim 1, wherein the one or more spreading rods traverse the separating along a linear path.

10. The toilet of claim 1, wherein the one or more spreading rods traverse the separating net along a circular path.
